(19) United States
(12) Patent Application Publication
(10) Pub. No.: US 2022/0099415 A1
(43) Pub. Date: Mar. 31, 2022

(54) SELF-SUPPORTING REACTION TARGET ASSEMBLY

(71) Applicant: P&P IMPORTS LLC, Irvine, CA (US)

(72) Inventors: Peter Tanoury, Newport Beach, CA (US); Casey Kempner, Huntington Beach, CA (US)

(73) Assignee: P&P IMPORTS LLC, Irvine, CA (US)

(21) Appl. No.: 17/034,835

(22) Filed: Sep. 28, 2020

(51) Int. Cl. F41J 5/24; B32B 7/12; B32B 21/02; B32B 21/08; B32B 37/12; B32B 38/00

(52) U.S. Cl. CPC F41J 5/24; B32B 7/12; B32B 21/02; B32B 2307/4023; B32B 37/12; B32B 38/145; B32B 21/08

(57) ABSTRACT

A self-supporting reaction target assembly is disclosed herein. In an embodiment, the target assembly includes a structural support layer, a first colorant layer on the structural support layer, a laminate film on the first colorant layer, and a second colorant layer on the laminate film. The target assembly can include a stake region and an image region. The stake region can have a material strength sufficient to be driven into a solid medium without fracture.

### TECHNICAL FIELD

The present disclosure generally relates to shooting target assemblies, and more particularly to an assembly for a self-supporting reaction target.

### BACKGROUND

Shooting targets are objects used for marksmanship training in various shooting sports including for pistol, rifle, and shotgun training. A bullseye target is a common shooting target that includes several concentric rings around a center circle, referred to as the bullseye. Shooting targets are typically printed on paper and hung above the ground from a post or structure.

Reaction targets are designed to provide a response when struck by a bullet. Various types of reaction targets exist including splatter targets, audible targets, and explosive targets. A “splatter” type paper target is printed on paper and designed to expose a bright-colored underlayer when shot by a projectile. By exposing a bright-colored underlayer, splatter-type paper targets allow for easier observation of a location where a bullet has penetrated the target. Audible targets are typically made out of steal and provide an audible sound when hit. Explosive targets include binary explosive-loaded containers (e.g., Tannerite) that are designed to detonate when punctured by a bullet.

### SUMMARY

In an embodiment, the target assembly includes a structural support layer, a first colorant layer on the structural support layer, a laminate film on the first colorant layer, and a second colorant layer on the laminate film. The target assembly can include a stake region and an image region. The stake region can have a material strength sufficient to be driven into a solid medium without fracture. The first colorant layer can be printed directly onto the structural support layer. Alternatively, the first colorant layer can be printed onto a substrate layer, and the substrate layer can be adhered to the structural support layer. A third colorant layer can be formed on the second colorant layer. The third colorant layer can be formed in an arrangement that illustrates an animal in an image region of the target assembly. The structural support layer can include a medium-density or high-density fiberboard material. The structural support layer can include a stake-shaped region configured to be driven into a solid medium. The first colorant layer, the laminate film, and the second colorant layer can be formed on the stake-shaped region of the structural support layer. Alternatively or additionally, the first colorant layer, the laminate film, and the second colorant layer can be formed on the structural support layer within an image region of the target assembly.

In an embodiment, the target assembly can include a structural support layer having a stake region and an image region. The stake region can be configured to be driven into a solid medium. A first colorant layer can be printed on the structural support layer. A laminate film can be formed on the first colorant layer. A second colorant layer can be formed on the laminate film. The first colorant layer, the laminate film, and the second colorant layer can be on the entire image region of the structural support layer and terminate above the stake region of the structural support layer or on a portion or the image region of the structural support layer. The first colorant layer can be printed directly onto the structural support layer. The first colorant layer can be printed onto a substrate layer. The substrate layer can be adhered to the structural support layer. A third colorant layer can be selectively deposited on the second colorant layer such that the third colorant layer illustrates an animal or another target image. The second colorant layer can have a color distinct from the first colorant layer. The third colorant layer can have a color distinct from the second colorant layer. The structural support layer can include a medium-density or high-density fiberboard material.

In an embodiment, a method for forming a target assembly can include forming a structural support layer having a stake region and an image region, printing a first colorant layer on a structural support layer, laminating a film on the first colorant layer, and adhering a second colorant layer on the laminated film. The film can be laminated on both the stake region and the image region. A third colorant layer can be formed onto the second colorant layer in an arrangement to produce an image.

### BRIEF DESCRIPTION OF THE DRAWINGS

The present disclosure is more readily apparent from the specific description accompanied by the following drawings, in which:

FIGS. 1A-1B are illustrations of a cross-sectional view of a self-supporting reaction target assembly, according to an embodiment;

FIG. 2 is an illustration of an exploded view of a self-supporting reaction target assembly, according to an embodiment;

FIGS. 3A-3B are illustrations of an example of a self-supporting reaction target assembly, according to an embodiment; and

FIGS. 4A-4B are illustrations of an example of a self-supporting reaction target assembly, according to an embodiment.

### DETAILED DESCRIPTION

Those of ordinary skill in the art will appreciate that depending on the particular application at hand, many modifications, substitutions and variations can be made in, and to, the materials, apparatus, configurations, and methods of use of the devices of the present disclosure, and the innovations herein are not limited to any of the particular embodiments that are illustrated and described herein. The description below is merely an explanation by way of some examples thereof that should be fully commensurate with that of the claims appended hereafter and their functional equivalents, and merely serves to inform one of ordinary skill in the art how to make and use the innovations disclosed herein.

Conventional reaction targets are typically printed on paper and hung above the ground from, e.g., a post or a tree. Conventional reaction targets are not self-supporting and do not have sufficient material strength for insertion into a solid media. If no post or tree is available, conventional reaction targets may not be useable. Thus, a reaction target that is useable even when a post or tree is not available would provide an improvement over conventional reaction targets.

Disclosed herein are various embodiments for a self-supporting reaction target assembly. The self-supporting reaction target assembly can include an image region and a stake region. The image region can include a splatter-type target and the stake region can be configured for insertion into a solid media (e.g., soil). Thus, the disclosed self-supporting reaction target does not require a post or tree for use. Rather, the disclosed structure can be inserted into a solid media (e.g., soil) and self-support the image region of the target assembly. Thus, the disclosed target assembly provides an improvement over conventional reaction targets.

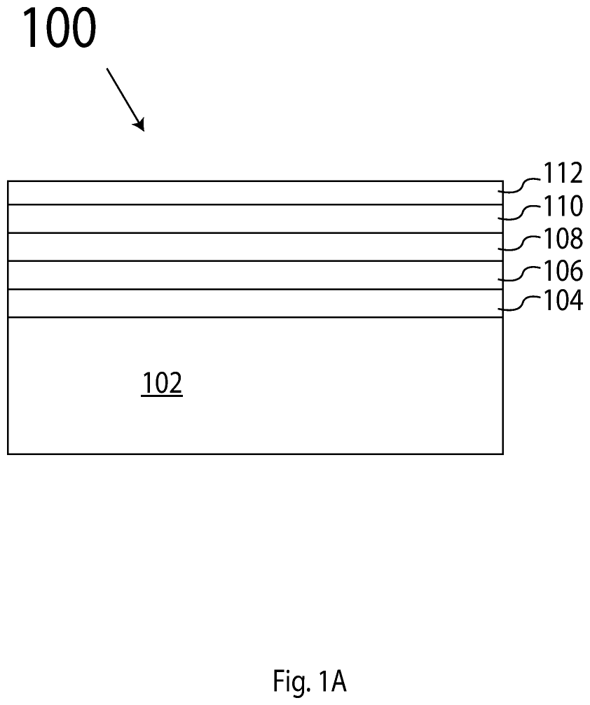

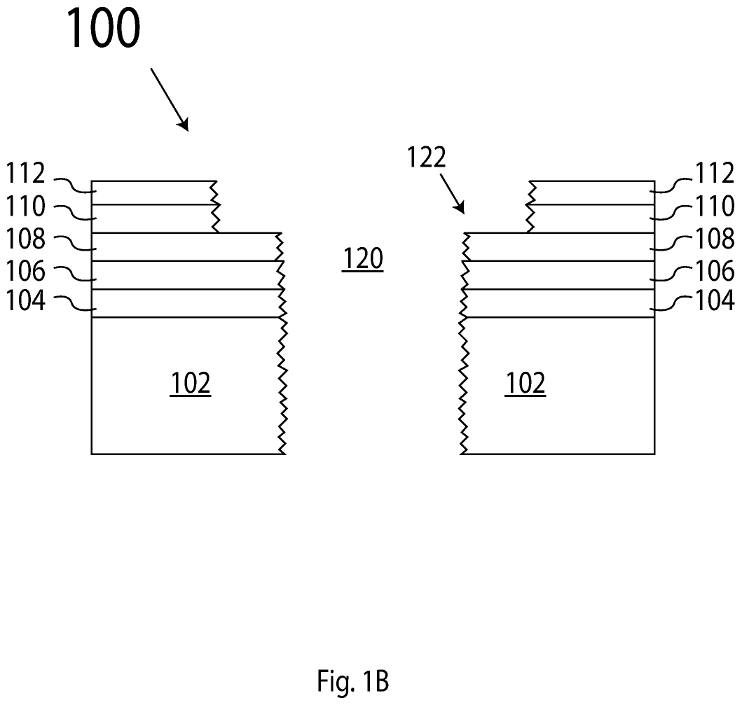

FIG. 1A is a cross-section view of a self-supporting reaction target assembly 100. Target 100 can include a structural backing layer 102, adhesive layer 104, first colorant layer 106, film 108 (e.g., laminate film), second colorant layer 110, and third colorant layer 112.

The structural backing layer 102 can be configured to support a target and be driven into the ground. Configurations of the structural backing layer 102 (e.g., different materials, densities, and/or thicknesses) provide sufficient material strength such that the image region is supported by the structural backing layer (e.g., image region does not easily fall forward) and a stake region can be driven into typical soil (e.g., by a force applied by a typical person).

The structural backing layer 102 can have a density ranging from approximately 250 kg per cubic meter to approximately 2000 kg per cubic meter, and ranges therebetween. For example, structural backing layer 102 can have a density ranging from approximately 200 kg per cubic meter to approximately 500 kg per cubic meter, approximately 500 kg per cubic meter to approximately 1000 kg per cubic meter, approximately 1000 kg per cubic meter to approximately 1500 kg per cubic meter, approximately 1500 kg per cubic meter to approximately 2000 kg per cubic meter, approximately 550 kg per cubic meter to approximately 750 kg per cubic meter, approximately 600 kg per cubic meter to approximately 800 kg per cubic meter, approximately 650 kg per cubic meter to approximately 850 kg per cubic meter, approximately 700 kg per cubic meter to approximately 900 kg per cubic meter, approximately 800 kg per cubic meter to approximately 1000 kg per cubic meter, approximately 850 kg per cubic meter to approximately 1050 kg per cubic meter, etc.

The structural backing layer 102 can be composed of, for example, a fiberboard material, a particleboard material, plywood, a composite material, or any combination thereof. Fiberboard materials include, for example, low-density fiberboard (e.g., particle board), medium-density fiberboard, and high-density fiberboard (e.g., hardboard). Fiberboard is more uniform than plywood but not entirely isotropic, since fibers are pressed tightly together through a sheet. Fiberboard can have a more consistent strength than plywood. Fiberboard can have more stable dimensions (e.g., less expansion and contraction) than plywood. Fiberboard can include a flat surface that may be smoother and more uniform than plywood. Higher density fiberboards may be capable of having smoother surfaces than lower density fiberboards.

The structural backing layer 102 can be composed of medium-density fiberboard. Various types of medium-density fiberboard are contemplated including, for example, ultralight medium-density fiberboard, moisture-resistant medium-density fiberboard, fire retardant medium-density fiberboard, or any combination thereof.

Medium-density fiberboard is more dense than low density fiberboard and less dense than high-density fiberboard. Medium-density fiberboard can have a density of approximately 700 kg per cubic meter to approximately 900 kg per cubic meter, and ranges therebetween. For example, the medium-density fiberboard can have a density ranging from 700 kg per cubic meter to approximately 750 kg per cubic meter, 725 kg per cubic meter to approximately 775 kg per cubic meter, 750 kg per cubic meter to approximately 800 kg per cubic meter, 775 kg per cubic meter to approximately 825 kg per cubic meter, 800 kg per cubic meter to approximately 850 kg per cubic meter, 825 kg per cubic meter to approximately 875 kg per cubic meter, 850 kg per cubic meter to approximately 900 kg per cubic meter, etc. In an embodiment, medium-density fiberboard can have a density of approximately 830 kg per cubic meter. Medium-density fiberboard having the above-indicated density can provide sufficient material strength to support an image region of the target assembly.

Medium-density fiberboard can include wood fiber, resin glue, water, and paraffin wax. Medium-density fiberboard can be formed by steaming wood chips (e.g., wood fiber) to generate a pulp, adding paraffin wax and defibrating the generated pulp, adding an adhesive (e.g., resin glue) to the generated pulp, hot-pressing the generated pulp to form a medium-density fiberboard, and shaping the medium-density fiberboard into the structural support having the stake region and the image region.

The structural backing layer 102 can have a thickness ranging from approximately 1.25 mm to approximately 15 mm and ranges therebetween. For example, the structural backing layer 102 can have a thickness ranging from approximately 1.25 mm to 2 mm, 2 mm to approximately 3 mm, 2.5 mm to approximately 4.5 mm, 4 mm to approximately 6 mm, 5.5 mm to approximately 6.5 mm, 6 mm to approximately 7 mm, 6.5 mm to approximately 7.5 mm, 7 mm to approximately 8 mm, 7.5 mm to approximately 8.5 mm, 8 mm to approximately 9 mm, 8.5 mm to approximately 9.5 mm, 9 mm to approximately 10 mm, 9.5 mm to approximately 10.5 mm, 10 mm to approximately 15 mm, etc. In some embodiments it is preferred to use high-density fiberboard or hard board for thicknesses under 2 mm. In other embodiments it is preferred to use medium density fiberboard for thicknesses between about 2 mm and 7 mm. In other embodiments it is preferred to use low-density fiberboard for thicknesses exceeding 7 mm. In yet other embodiments, a combination of medium-density fiberboard and low-density fiberboard are used.

In an embodiment, the adhesive layer 104 can be used to bind the structural backing layer 102 with the first colorant layer 106. In another embodiment, the first colorant layer 106 can be applied directly to the structural backing layer 102 without the adhesive layer 104. The use of the adhesive layer 104 can depend on the composition of the first colorant layer 106. For example, if the first colorant layer 106 is comprises a paper layer with an ink layer (e.g., brightly colored ink) on the paper layer, then the paper and ink combination may be bound with the structural backing layer 102 with an adhesive. However, if the first colorant layer 106 consists of only an ink layer, then the first colorant layer 106 can be applied directly onto the structural backing layer 102 without the adhesive layer 104. Thus, existence of the adhesive layer 104 can be contingent on composition and/or properties of the first colorant layer 106.

The film 108 can be formed over the first colorant layer 106. Forming the film 108 over the first colorant layer 106 can include a lamination process. Lamination can increase a material strength of the target assembly 100. By increasing the material strength of the target assembly 100, film 108 can allow the target assembly to be driven into a solid medium (e.g., soil) without (or with minimal) fracturing. Thus, film 108 can be applied to a stake region of the target assembly 100. In certain embodiments the addition of film 108 can further reduce friction when inserting the stake region into the ground.

The film 108 can be an elastically deformable material and include an upper surface with low dyne. The film 108 can be composed of, for example, polyethylene (PE), polypropylene (PP), polymethylpentene (PMP), polybutene-1 (PB-1), polyisobutylene (PIB), ethylene propylene rubber (EPR), ethylene propylene diene monomer (M-class) rubber (EPDM rubber), resin, polytetrafluoroethylene (PTFE), polyurethane, another polymer, or any combination thereof.

The film 108 can have a modulus of elasticity (Youngs modulus) ranging from approximately 0.005 GPa to approximately 10 GPa, and ranges therebetween. For example, the film 108 can have a modulus of elasticity ranging from approximately 0.008 GPa to approximately 8.25 GPa, approximately 0.050 GPa to approximately 8 GPa, approximately 0.10 GPa to approximately 7 GPa, approximately 1 GPa to approximately 6 GPa, approximately 1.5 GPa to approximately 5 GPa, approximately 2 GPa to approximately 4 GPa, approximately 2.5 GPa to approximately 5 GPa, approximately 3 GPa to approximately 6 GPa, etc.

FIG. 1A illustrates a physical disturbance site 120 (e.g., a bullet hole). The physical disturbance site 120 includes a separation region 122 where the second colorant 110 has detached from the film 108 while the first colorant layer 106 remains attached to the structural backing layer 102. Forming the first colorant layer 106 onto the structural backing layer 102 provides a performance improvement over conventional methods. Conventionally, a substrate for a reaction target is composed of paper which easily frays around a projectile impact site. When the substrate frays, any colorant attached to the substrate may become more difficult to observe. The structural backing layer 102 has significantly less fraying about an edge of a projectile impact site, making the first colorant layer 106 more prominent when exposed. Thus, when the first colorant layer 106 is exposed, a more prominent halo effect is created compared to conventional reaction targets.

Detachment of the second colorant 110 from the film 108 can occur due to a weak bond between the second colorant layer 110 and the film 108. A low surface energy upper surface of the film 108 can weaken a surface tension between the second colorant layer 110 and the film 108. The ability of a material to anchor another material (e.g., the second colorant layer 110) can be related to the surface energy of the material. Conventionally colorant application processes involve configuring a material to receive a colorant by ensuring that the material has a higher surface energy than the surface tension of the colorant so that the material anchors the colorant into place. However, in an embodiment, the surface energy of the film 108 can be less than the surface tension of the second colorant layer 110. In another embodiment, the surface energy of the film 108 does not significantly exceed the surface tension of the second colorant layer 110.

Low surface energy of the film 108 relative to a surface tension of the second colorant layer 110 can result in the second colorant layer 110 detaching from the film 108 when disturbed. For example, a physical disturbance (e.g., a bullet impact) can cause the second colorant layer 110 to slip off the film 108, resulting in visible exposure of the underlying first colorant layer 106. For example, the second colorant layer 110 can detach around a physical disturbance site (e.g., halo around a bullet hole).

In certain embodiments, the film 108 is deformed (e.g., stretched) upon impact by a projectile, which alters the surface tension causing the second colorant layer to separate from the film 108 in the area of deformation. In certain embodiments this causes a 1 mm to 5 mm reaction zone (ring of exposure of layer 106) around the impact area. In certain embodiments the reaction zone may be larger, for example 3 mm to 10 mm. In certain embodiments, the thicknesses of layer 102 provided herein may be used to adjust the reaction zone. For example, in certain embodiments, for a given density of layer 102, increased thickness shall result in a smaller reaction zone. This may be desirable for increasing the ability to distinguish a higher number projectiles in a given area and is also associated with longer target life. In other embodiments, for a given density of layer 102, decreased thickness shall result in a larger reaction zone. This may be desirable for increasing the distance in which the reaction zone may be seen. In at least one embodiment, a thickness of layer 102 between 2 mm and 4 mm of medium-density fiberboard provides a reaction zone viewable at typical range shooting distances between 5 yards and 50 yards.

In certain embodiments, the density of layer 102 provided herein may be used to adjust the reaction zone. For example, in certain embodiments, for a given thickness of layer 102, increased density shall result in a smaller reaction zone. This may be desirable for increasing the ability to distinguish a higher number projectiles in a given area and is also associated with longer target life. In other embodiments, for a given thickness of layer 102, decreased density shall result in a larger reaction zone. This may be desirable for increasing the distance in which the reaction zone may be seen. In at least one embodiment, a density of layer 102 between 700-900 kg per cubic meter provides a reaction zone viewable at typical range shooting distances between 5 yards and 50 yards.

The underlying first colorant layer 106 can be visibly distinct from the second colorant layer. The first colorant layer 106 can be, for example, a neon color (e.g., bright green). The second colorant layer 110 can be, for example, a neutral color (e.g., white, brown, or black). Contrasting a neutral color with a neon color can result in a more perceptible halo effect around a physical disturbance (e.g., bullet hole).

In an embodiment, a third colorant layer 112 can be formed over the second colorant layer 110. An upper surface of the second colorant layer 110 can have sufficient surface energy to bond with the third colorant layer 112. If a physical disturbance occurs (e.g., bullet hole created), the third colorant layer 112 can remain bonded to the second colorant layer 110, and slip off of the film 108 along with the second colorant layer 110. Thus, a physical disturbance to target 100 can result in the second colorant layer 110 slipping off of a region around the disturbance along with subsequent layers bonded to the colorant layer 110 (e.g., third colorant layer 112 or one or more additional colorant layers). Additional colorant layers can be used to provide more detail to a target image (e.g., shading lines better representing an image of an animal).

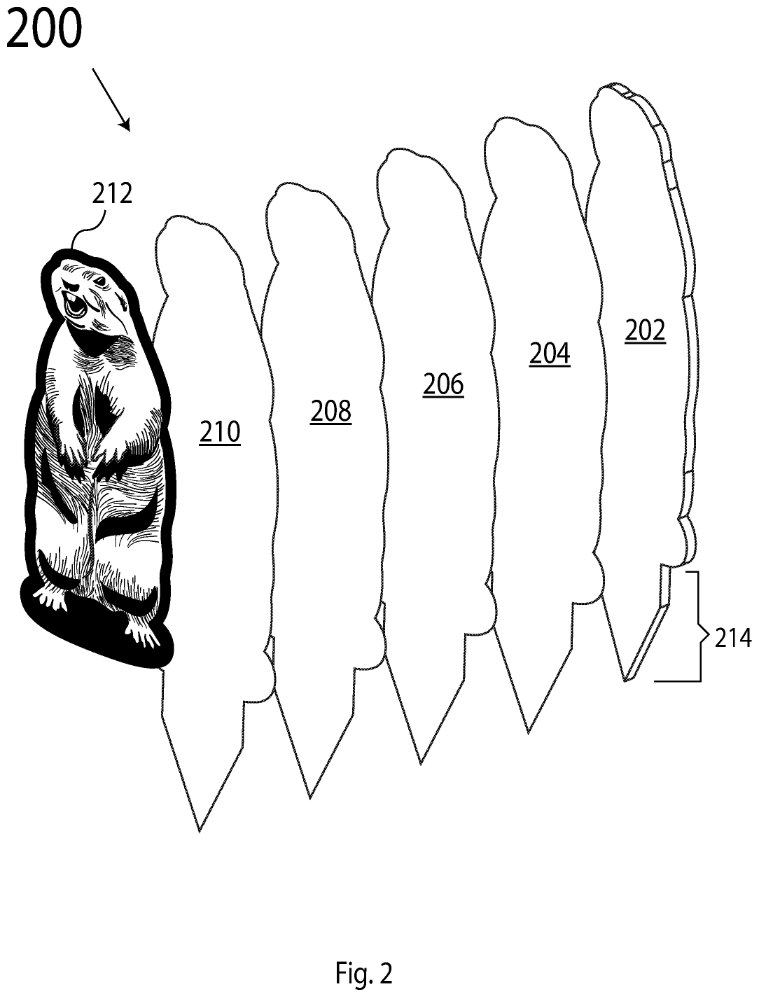

FIG. 2 illustrates an exploded view of a self-supporting reaction target assembly 200. Target assembly 200 includes a plurality of layers including, for example, a structural backing layer 202, adhesive layer 204, first colorant layer 206, film 208, second colorant layer 210, and third colorant layer 212. One or more layers can be formed in a stake region 214 and/or an image region above the stake region 214. Stake region 214 can be stake-shaped. Stake region 214 can include a pointed end with a taper in one or more dimensions such that a width of the stake shaped region gradually increases as a distance from the pointed end increases. A top boundary of the stake region can be adjacent to a bottom boundary of an image region.

The stake region 214 can be configured for insertion into one or more types of solid media (e.g., soil, dirt, sand, clay, extruded polystyrene foam, etc.). The stake region 214 can have a material strength sufficient for insertion into the one or more types of solid media without catastrophic fracture. All or a majority of the material strength of the stake region 214 can reside in a portion of the structural backing layer 202 within the stake region 214. One or more layers over the structural backing layer 202 can add additional material strength to the stake region 214. For example, film 208 can act in concert with the structural backing layer 202 to provide greater material strength to the stake region 214 than would exist in the materials individually, and in some embodiments reduce friction to aid insertion into the one or more types of solid media.

In addition to creating a halo effect (as discussed above with respect to FIG. 1A) in an image region of a target assembly, a film layer (e.g., film 208) can also be formed in a stake region to increase material strength of the stake region. Film 208 can be laminated onto a first colorant layer 206 on the structural backing layer 202. Lamination can increase a material strength of the target assembly 200. By increasing the material strength of the target assembly 100, film 208 can allow the target assembly to be driven into a solid medium (e.g., soil) without (or with minimal) fracturing. Thus, film 208 can serve a dual purpose of both enabling a halo effect in an image region and reducing or eliminating fracturing in a stake region of the target assembly 200. In some embodiments wherein stake region 214 includes film 208, the thickness of layer 202 may be reduced because of the additional strength added by film 208 to stake region 214.

In certain embodiments, the stake region 214 can have a compressive strength ranging from approximately 28 MPa to approximately 42 MPa. For example, the compressive strength of the stake region 214 can be greater than 28 MPa, 30 MPa, 32 MPa, 34 MPa, 36 MPa, 38 MPa, 40 MPa, or 42 MPa.

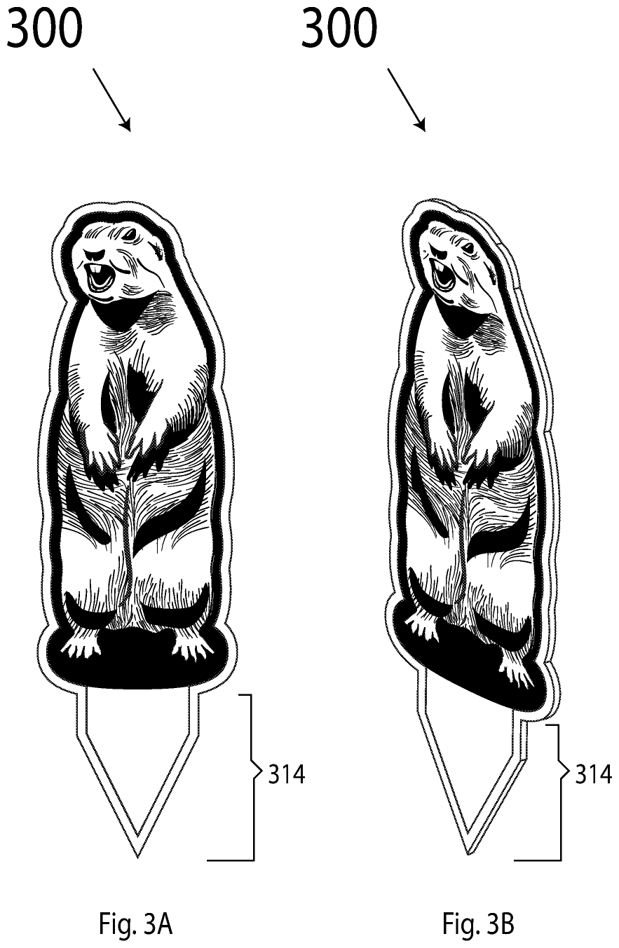

FIGS. 3A and 3B illustrate the self-supporting reaction target assembly 300. The target assembly 300 can include a structural backing layer, an adhesive layer, a first colorant layer, a film, a second colorant layer, and a third colorant layer. The target assembly can include an image such as an image of an animal (e.g., a gopher), a bullseye, a circle, or another printable image. The image can result from an arrangement of one or more colorant layers (e.g., a second and third colorant layer) on the film. The third colorant layer can be selectively deposited on the second colorant layer in an arrangement that illustrates an animal.

A stake region 314 of the target assembly 300 can be configured for insertion into a solid medium. The stake region 314 can include one or more layers that provide sufficient material strength for insertion into the solid medium without catastrophic fracture of the target assembly 300. For example, a film layer over a structural backing layer within the stake region 314 can increase a compressive strength of the target assembly 300 and reduce a likelihood of fracture when the target assembly 300 is inserted into a solid medium. The stake region 314 can have a compressive strength exceeding 28 MPa.

The stake region 314 can include a pointed tip at a bottom end and a gradual taper that increases at least one dimension (e.g., width, diameter, etc.) towards a target image region (e.g., image of a gopher) of the target assembly 300. The stake region 314 can be driven into a solid medium (e.g., soil) such that an image region (e.g., image of a gopher) of the structural support layer extends vertically above the solid medium with sufficient rigidity to be shot with a projectile. The rigidity of the image region combined with the stake region having sufficient material strength for insertion into a solid medium allows the target assembly to be self-supporting.

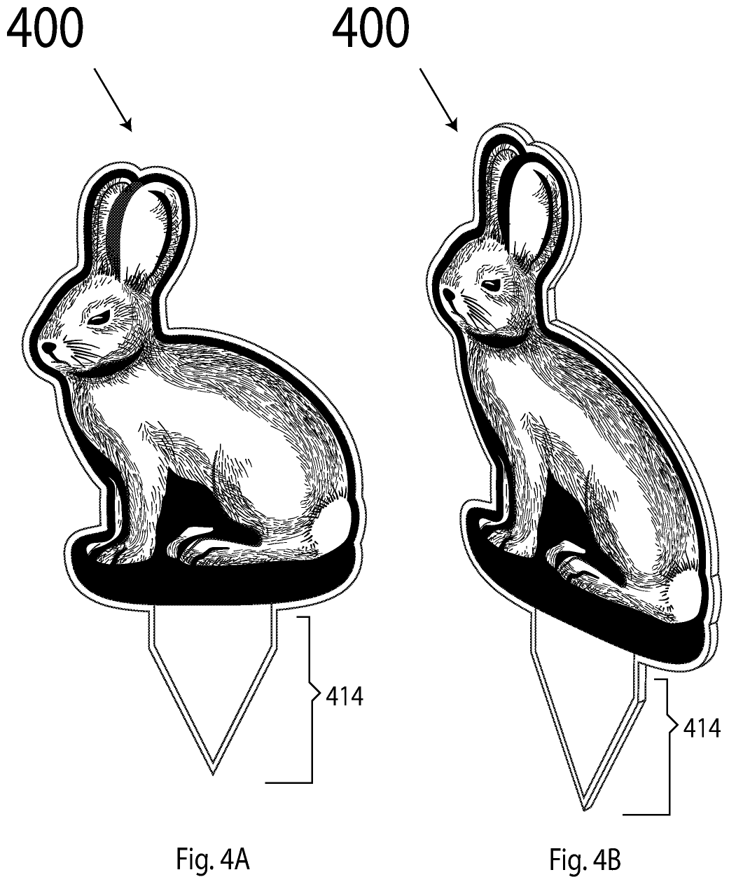

FIGS. 4A and 4B illustrate a self-supporting reaction target assembly 400. The self-supporting reaction target assembly 400 can include a structural backing layer, adhesive layer, a first colorant layer, a film, a second colorant layer, and a third colorant layer. The target assembly can include an image such as an image of an animal (e.g., a rabbit), a bullseye, a circle, or another image produced via colorant layer(s) on the film. The third colorant layer can be selectively deposited on the second colorant layer in an arrangement that illustrates an animal.

A stake region 414 of the target assembly 400 can be configured for insertion into a solid medium. The stake region 414 can include one or more layers that provide sufficient material strength for insertion into the solid medium without catastrophic fracture of the target assembly 400. For example, a film layer over a structural backing layer within the stake region 414 can increase a compressive strength of the target assembly 400 and reduce a likelihood of fracture when the target assembly 400 is inserted into a solid medium. The stake region 414 can have a compressive strength exceeding 28 MPa.

The stake region 414 can include a pointed tip at a bottom end and a gradual taper that increases at least one dimension (e.g., a width, a diameter, etc.) towards a target image region (e.g., image of a rabbit) of the target assembly 400. The stake region 414 can be driven into a solid medium (e.g., soil) such that an image region (e.g., image of a rabbit) of the structural support layer extends vertically above the solid medium with sufficient rigidity to be shot with a projectile. The rigidity of the image region combined with the stake region having sufficient material strength for insertion into a solid medium allows the target assembly to be self-supporting.

The disclosed reaction target provides an improvement over conventional targets by, for example, providing a self-supporting structure configured for insertion into a solid medium and having sufficient material strength to support an image region. Unlike conventional targets, an additional support (e.g., post or tree) is not required.

Various embodiments further improve performance of the reaction target. For example, a film (e.g., film 108) can be applied to a stake region to both increase material strength and reduce friction upon insertion into solid media (e.g., soil). In another example, colorant can be applied onto a structural backing layer to better hold the colorant in place upon impact by a projectile resulting in a more prominent halo effect. Various other examples of performance improvements are discussed throughout the present disclosure.

In certain aspects, the reference to the singular form of a word may also refer to the plural, and a reference to the plural form of a word may refer to the singular thereof. While some of the advantages of the targets disclosed herein are provided, the advantages are not limited to those described herein, as one of ordinary skill in the art will apricate more advantages and embodiments than those explicated listed or described herein.

What is claimed is:

1. A target assembly, comprising:
a structural support layer;
a first colorant layer on the structural support layer;
a laminate film on the first colorant layer; and
a second colorant layer on the laminate film.

2. The target assembly of claim 1, wherein the first colorant layer is printed directly onto the structural support layer.

3. The target assembly of claim 1, wherein the first colorant layer is printed onto a substrate layer, the substrate layer being adhered to the structural support layer.

4. The target assembly of claim 1, further comprising:
a third colorant layer on the second colorant layer.

5. The target assembly of claim 4, wherein the third colorant layer illustrates an animal in an image region of the target assembly.

6. The target assembly of claim 1, wherein the structural support layer comprises a medium-density or high-density fiberboard material.

7. The target assembly of claim 1, wherein the structural support layer includes a stake-shaped region configured to be driven into a solid medium.

8. The target assembly of claim 7, wherein the first colorant layer, the laminate film, and the second colorant layer are on the stake-shaped region of the structural support layer.

9. The target assembly of claim 1, wherein the first colorant layer, the laminate film, and the second colorant layer are formed on the structural support layer within an image region of the target assembly.

10. A target assembly, comprising:
a structural support layer having a stake region and an image region, the stake region configured to be driven into a solid medium;
a first colorant layer printed on the structural support layer;
a laminate film on the first colorant layer; and
a second colorant layer on the laminate film.

11. The target assembly of claim 10, wherein the first colorant layer, the laminate film, and the second colorant layer are on the image region of the structural support layer and terminate above the stake region of the structural support layer.

12. The target assembly of claim 10, wherein the first colorant layer is printed directly onto the structural support layer.

13. The target assembly of claim 10, wherein the first colorant layer is printed onto a substrate layer, the substrate layer being adhered to the structural support layer.

14. The target assembly of claim 10, further comprising:
a third colorant layer selectively deposited on the second colorant layer such that the third colorant layer illustrates an animal.

15. The target assembly of claim 10, wherein the second colorant layer has a color distinct from the first colorant layer, and the third colorant layer has a color distinct from the second colorant layer.

16. The target assembly of claim 10, wherein the structural support layer comprises a medium-density or high-density fiberboard material.

17. A method for forming a target assembly, the method comprising:
forming a structural support layer having a stake region and an image region;
printing a first colorant layer on a structural support layer;
laminating a film on the first colorant layer; and
adhering a second colorant layer on the laminated film.

18. The method of claim 17, wherein the film is laminated on both the stake region and the image region.

19. The method of claim 17, further comprising:
printing a third colorant layer onto the second colorant layer in an arrangement to produce an image.
